(19) United States
(12) Patent Application Publication
(10) Pub. No.: US 2006/0271486 A1
(43) Pub. Date: Nov. 30, 2006

(54) Digital publication system and apparatus

(76) Inventors: Damian Cross, Las Vegas, NV (US); Rick LeVine, Hollywood, CA (US); Antonio Thor Fraser, Hollywood, CA (US)

Correspondence Address: KOPPEL, PATRICK & HEYBL, 555 ST. CHARLES DRIVE, SUITE 107, THOUSAND OAKS, CA, 91360, US

(21) Appl. No.: 11/418,643

(22) Filed: May 4, 2006

Related U.S. Application Data
(60) Provisional application No. 60/680,844, filed on May 12, 2005.

(51) Int. Cl. G06Q 99/00

(52) U.S. Cl. 705/51

(57) ABSTRACT

Embodiments of the present invention are directed to a digital publication system configured to operate in conjunction with a communication network having a content provider system, and a host device operated by a user. The digital publication system comprises an authentication system, a data distribution system and a secure processing system, wherein the authentication system is configured to provide authorization for the user to access the digital publication system. The data distribution system further comprises a data locator and a data request manager, wherein the data locator and data request manager operate in conjunction with each other to provide requested data to the host device. The secure processing system comprises a protocol application for securing the transmission of some user information to and from the host device, wherein securing the transmission.

### RELATED APPLICATION

This application claims the benefit of U.S. Patent Application Ser. No. 60/680,844 entitled Digital Magazine and System, filed on May 12, 2005, and is fully incorporated herein by reference.

### FIELD OF THE INVENTION

The invention is directed to a digital publication system and apparatus that is configured to assess the performance specifications of a user's device prior to providing content to the user. In particular, embodiments of the invention are directed to a digital publication, wherein a user is provided with a portion of the digital publication on a host device for use in conjunction with a digital publication system provider via a communication network.

Background of the Invention The advent of wide area communication networks, including, but not limited to, the Internet and other networks including, for example, networks providing cell phone service, and the expansive availability of such networks, has provided new opportunities for existing businesses and further, has provided the opportunity for the creation of new businesses and business models. In particular, the introduction of wide area communication networks has provided the basis for the proliferation of online businesses.

Many online businesses are extensions of existing brick and mortar businesses. However, a large number of businesses only exist on a wide area communication network and are presented to the user via images and text that create the presentation of the business to users via their network connection.

A user's network connection is generally linked, either wirelessly, physically or a combination thereof, to hardware including, but not limited to, a personal computer, a personal digital assistant (PDA), gaming device, an iPOD or iPOD-like device, and other handheld devices and hardware, either alone, or in combination with each other.

The presentation of the business may reflect various forms, depending upon a user's hardware. If a user's hardware is a personal computer, the most common form of presentation is a webpage, wherein a collection of webpages directed to a specific theme, topic or subject, for example a specific business, is called an online business. If the user's hardware is a cell phone, PDA, or a non-personal computer-type device, the presentation is substantially similar in appearance to a webpage and is often derived from similar technology.

Some online businesses offer a wide variety of multimedia materials, including graphics, images, text, videos, and combinations of media. These businesses provide a type of online publication of media that a user can peruse similar to a paper magazine. These online publications, however, offer a wider variety of material than a paper publication, including interactive content, live content, flash presentations, videos, music, audio files, stories, and other content.

Unlike a traditional publication, however, to view the online publication a user must download the information provided by a content provider to a user computer. In light of the wide variety of information available to the user, the user computer must have the ability to receive various types of data, including, for example, the ability to accept or utilize a minimum amount of bandwidth or available connectivity. However, even if a user has the minimum connectivity required to transmit a specific set of data, it still may be difficult to easily or quickly download all of the data intended to be transmitted to the user computer upon accessing the content provider.

Due to varying connectivity ability among users, limitations exist regarding the ease of the distribution of information from one user, for example, a merchant, to another user, for example, a consumer. Due to this problem, some online businesses cannot easily be accessed by some users, and thus, the user is effectively prohibited from interacting with these online business as difficulties of downloading information interferes with the enjoyment of the online business. For example, a user having low bandwidth capability will require a longer amount of time to download movies, video clips and even some images. Thus, some users will simply not be able to fully participate in receiving online content or may be restricted as to what is available. Further, variations in storage capacity and processing speed of communication and computer hardware, and similar devices, affect distribution and receipt of content.

Like paper publications, these online publications are rarely free, and typically, are purchased via an on-line transaction. To purchase goods or services typically includes the entering of sensitive financial and personal information, for example, a credit card number, date of birth, and address. To protect consumers, payment-processing methods in use by online businesses, in particular businesses that accept payments via online connections, generally provide a secure payment modality, such as that provided by secure sockets layer (“SSL”).

SSL is a commonly used protocol for managing the security of message transmission on wide area communication networks and is included as part of widely available web browsers, such as the Netscape Browser, Microsoft's Internet Explorer, the Mozilla Foundation's Firefox browser, the Macintosh's Safari browser, and many others. When a user clicks a payment button on a provider's online business, a secure sockets layer is opened for the transmission of encrypted data, and then a payment screen is presented to the user.

The information displayed to the user in this secure sockets layer resides on either the merchant's computer(s), if the merchant handles its own payment transactions, or on a third-party payment processor's computer(s), if the merchant contracts with such a third party to handle payment transactions. The SSL creates a “tunnel-like” environment, wherein information from the user is directly transmitted to the payment processor for the merchant and confirmation or other data is transmitted directly back to the user.

Although the transmission of the payment information is transmitted directly to the payment processor through the tunnel-like environment to prevent third parties unrelated to the transaction, such as hackers, from viewing the transaction as it occurs, the transmitted information can be viewed and recorded by the merchant. An unscrupulous merchant or merchant's employee could use the information for illicit purposes.

Additionally, the word “secure” in “secure sockets layer” only refers to the safe tunnel-like environment of the transmission between the user's computer and the computer accepting payment for a given transaction. However, SSL does not prevent those responsible for creating the payment processing webpages to insert code, for example “backdoor access code,” to allow backdoor access into the webpage that allows the recording of information entered into the SSL, such as user payment information for use at a later date. For example, employees or contractors who create payment-processing webpages can cause such webpages to record keystrokes entered by the user into those pages for identity theft use at a later date. A merchant may not even be aware that the person contracted to build the merchant's online business has built into that online business such backdoor access.

Although this manner of payment is acceptable for most online businesses, some online businesses containing restricted content, such as adult entertainment content, are regulated such that the providers of these online businesses must operate under more stringent restrictions regarding user payment information. Such providers are prohibited from viewing or having any access to users' payment information, or storing users' payment information, even temporarily.

Third party payment processing for online businesses containing restricted content, such as adult entertainment webpages, differs from the processing of payments for online businesses in non-regulated industries. In particular, a payment screen is presented to the user and the user is transmitted from the web site of the regulated business to a payment processor. In this regard, the user's experience on the web site of the regulated business is interrupted. After payment is successfully made, the independent third-party processor transmits an electronic communication to the adult entertainment company associated with the adult entertainment online business confirming that payment has been received. Upon receipt of this confirmation, the user is granted access to the adult entertainment online business within a time frame ranging from a few seconds to 24 hours.

User access after successful payment can occur either by the third party payment processor's online business automatically transferring the user back to the adult entertainment online business; by the user manually entering in the address of the adult entertainment online business; or by the user manually accessing his email, retrieving an emailed access code forwarded from the payment processor, manually entering the address of the adult entertainment online business, accessing the online business and entering in his access code. Regardless of how access is acquired after successful payment, the user experience of the adult entertainment online business is interrupted by the required connection to the independent third party payment processor's online business.

A need exists in the industry for an electronic publication that allows a user substantially full access to the publication regardless of the user's hardware specifications. A further need exists in the industry for a secure payment environment which protects consumers and fully complies with regulatory requirements prohibiting content providers or those who create webpages for them from having the ability to view and record consumer information while not causing an interruption with the user's activities on the primary content provider's online business.

### BRIEF DESCRIPTION OF THE DRAWINGS

The detailed description of embodiments of the invention will be made with reference to the accompanying drawings, wherein like numerals designate corresponding parts in the figures.

FIG. 1 depicts a secure processing system that operates in accordance with preferred embodiments of the invention.

FIG. 2 is a block diagram of a digital publication in accordance with a preferred embodiment of the invention.

FIG. 3 is a schematic of a readable medium in accordance with the preferred embodiment of FIG. 2.

FIG. 4 is a schematic of the remote and local authenticators in accordance with the preferred embodiment of FIG. 2.

FIG. 5 is a schematic of a distributed data repository in accordance with the preferred embodiment of FIG. 2.

FIG. 6 is a schematic of a secure payment processing system in accordance with a preferred embodiment of the invention.

FIG. 7 is a schematic of a secure payment processing transmissions in accordance with the preferred embodiment of FIG. 6.

FIG. 8 is a schematic of a secured payment screen presented to the user on a primary web page without borders in accordance with a preferred embodiment of the invention.

FIG. 9 is a block diagram of a method of operation of the digital publication system in accordance with a preferred embodiment of the invention.

FIG. 10 is a block diagram of the main navigation menu of the digital publication in accordance with a preferred embodiment of the invention.

FIG. 11 is a schematic of a media assembler in accordance with preferred embodiments of the invention.

### SUMMARY OF THE DISCLOSURE

Embodiments of the present invention are directed to a digital publication system configured to operate in conjunction with a communication network having a content provider system, and a host device operated by a user. The digital publication system comprises an authentication system, a data distribution system and a secure processing system, wherein the authentication system is configured to provide authorization for the user to access the digital publication system. The data distribution system further comprises a data locator and a data request manager, wherein the data locator and data request manager operate in conjunction with each other to provide requested data to the host device. The secure processing system comprises a protocol application for securing the transmission of some user information to and from the host device, wherein securing the transmission prohibits the content provider system from accessing and viewing the information.

A feature of preferred embodiments of the invention is a readable medium having at least a portion of content from a distributed data repository. An advantage to this feature is that a user computer having poor or low connectivity ability is able to more easily access at least a portion of the content on the provider computer.

A further feature is that the readable medium is configured to interact with online content associated with the digital system on a subscription basis. An advantage to this feature is that a more enhanced and dynamic publication can be presented to the user.

A still further feature is that access to the readable medium can be restricted as well as the online portion of the digital publication system. An advantage to this feature is that the data of the publication can be protected from unrestricted distribution.

A further feature of preferred embodiments is a secure payment processing system, the secure payment processing system being configured to provide security for transactions without causing an interruption of the user's access to the provider computer while preventing the viewing or recording of the user's data from the provider computer. An advantage to this feature is that the user's activities on the provider computer are not interrupted. A further advantage is that the provider remains compliant with any regulations governing payment transactions.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### Detailed Description of Preferred Embodiments

Preferred embodiments of the invention operate on a wide area communication network system via a variety of devices, such as, a personal computer, a personal digital assistant (PDA), gaming device, cell phone, an iPOD or iPOD-like device, or other handheld devices, that can be coupled to a network and that are configured to operate within the boundaries of the network system.

Hardware Requirement:

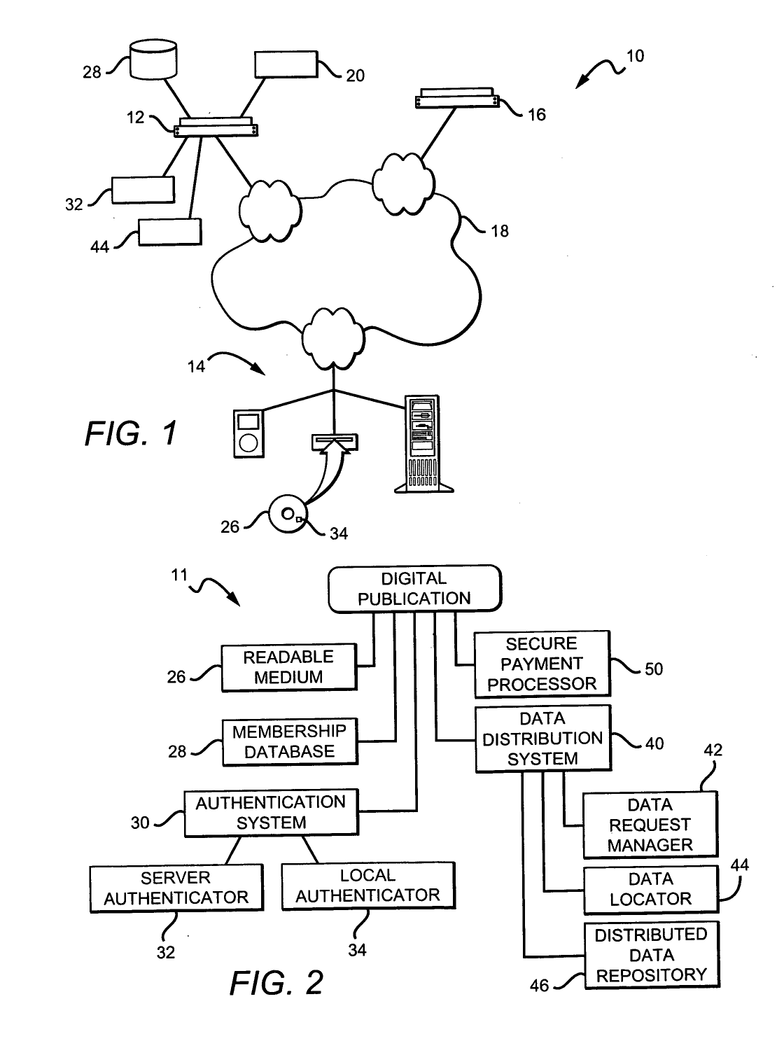

Preferred embodiments of the invention operate in accordance with a plurality of networked computers, such as, for example, a host device (such as a personal computer) and a content provider computer coupled together via a wide area communication network. In preferred embodiments, with reference to FIG. 1, the network system 10 includes a content provider system 12, a host device 14, and a third-party payment processor system 16, wherein the content provider system 12, the host device 14, and the payment processor system 16 are in electronic communication with each other via a network connection 18. It is to be understood that the content provider system 12, the host device 14, and the third-party payment processor system 16 can operate on separate network connections, wherein the individual network connections couple with the network connection 18 such that each element is in electronic communication.

In some preferred embodiments, the network system 10 depicted in FIG. 1 includes a plurality either of the content provider system 12, the host device 14, the payment processor system 16 or any combination thereof. The content provider system 12 contains information directed to a business, or defined subject matter, such as an on-line publication, that is accessible by the host device 14.

The network system depicted in FIG. 1 can include one or more content provider systems 12 that are operatively linked to the network connection 18, wherein each of the content provider systems 12 can contain a wide variety of information directed to a particular business, or defined subject matter. Additionally, it is anticipated that multiple host devices 14 will couple to and access the content provider systems 12.

The content provider system 12 may comprise any suitable networked computer system capable of providing content (data representing text, hypertext, photographs, graphics, video, audio, and others) for communication via a network connection 18. In preferred embodiments, the content provider system 12 comprises a computer system capable of operating in accordance with programs stored on one or more computer-readable media (for example, but not limited to, digital storage, magnetic storage, random access memory [RAM] or RAM-like electronic memory storage) to provide content for communication to host devices 14 and payment processors 16.

The content provider system 12 may include one or more internal or external data storage devices 20 for storing content for communication to a host device 14. The content provider system 12 is controlled by suitable software to provide the desired content to the requesting host device 14.

In a preferred network environment the content provider system 12 is controlled by suitable software to respond to a request for content by transmitting via the network connection 18, data compatible with the host device 14 that made the request. It will be understood by those skilled in the art that this process involves communications through suitable servers, routers, and other components, as is dictated by the particular network environment.

Each component of the content provider system 12 operates with a storage means (not shown) for example, one or more of fixed and/or removable data storage devices and/or data communications devices connected to the content provider system 12. The network connection 18 may be accessed via a public network, a private network, a local area network, or any other suitable communications connection, hardwired, wireless, or a hybrid thereof The host device 14 and payment processor system 16 may comprise any suitable network device capable of communicating with other network devices in the network system. In preferred embodiments, the host device 14 and payment processor system 16 comprises a processor capable of operating in accordance with programs stored on one or more computer readable media (for example, but not limited to floppy disc, hard disc, computer network, random access memory (RAM), CD Rom, or the like), a display device for providing a user-perceivable display (for example, but not limited to visual displays, such as cathode ray tube CRT displays, light-emitting-diode LED or liquid-crystal-diode LCD displays, plasma displays or the like, audio displays or tactile displays), and a user input device (for example, but not limited to, a keyboard, mouse, microphone, or the like). In preferred embodiments, the host device 14 may comprise any suitable personal computer, a personal digital assistant (PDA), gaming device, an iPOD or iPOD-like device, or other handheld device capable of receiving user input and displaying content. The payment processor system 16 may comprise any suitable computing device capable of receiving, processing and responding to requests for information. In preferred embodiments, the payment processor system 16 is configured to directly communicate with the host device 14 via the network connection 18.

### General Description of Preferred Embodiments

Embodiments of the present invention are directed to a digital publication system and apparatus. Embodiments of the digital publication system can operate in conjunction with a network, such as the network illustrated in FIG. 1. In preferred embodiments, the digital publication comprises a distributed data repository (discussed below) and is configured to transmit at least a portion of the repository to the host device 14.

Overall, the digital publication system creates an interactive system linking a readable storage medium with an online subscription membership program, such as a website. The digital publication system distributes readable medium to users, wherein the readable medium is a storage device containing content. Users can obtain a copy of the readable medium by any suitable means, including but not limited to, accessing the online membership program and requesting a copy to be sent via mail, as part of the membership program, contacting the content provider system, such as the publisher or distributor, via telephone, or by obtaining a copy from a brick and mortar location, such as, a retail store, gas station and the like.

The readable medium links to content resident online and at remote locations and allows a user interaction with the online membership program. In this regard, the readable medium provides a portion of the digital publication which can be augmented via the content from the online membership. In preferred embodiments, the digital publication system creates a monthly or periodic subscription based program.

With reference to FIGS. 1 and 2, embodiments of the digital publication system 11 comprise a readable medium 26, a membership database 28, an authentication system 30, a data distribution system 40, and a secure processing system 50. The readable medium 26 is a device that can store information, including, for example, executable programs, text and graphics. Any readable medium capable of receiving and storing data, including, but not limited to, floppy discs, CD-ROMs, DVDs, and digital medium, are suitable.

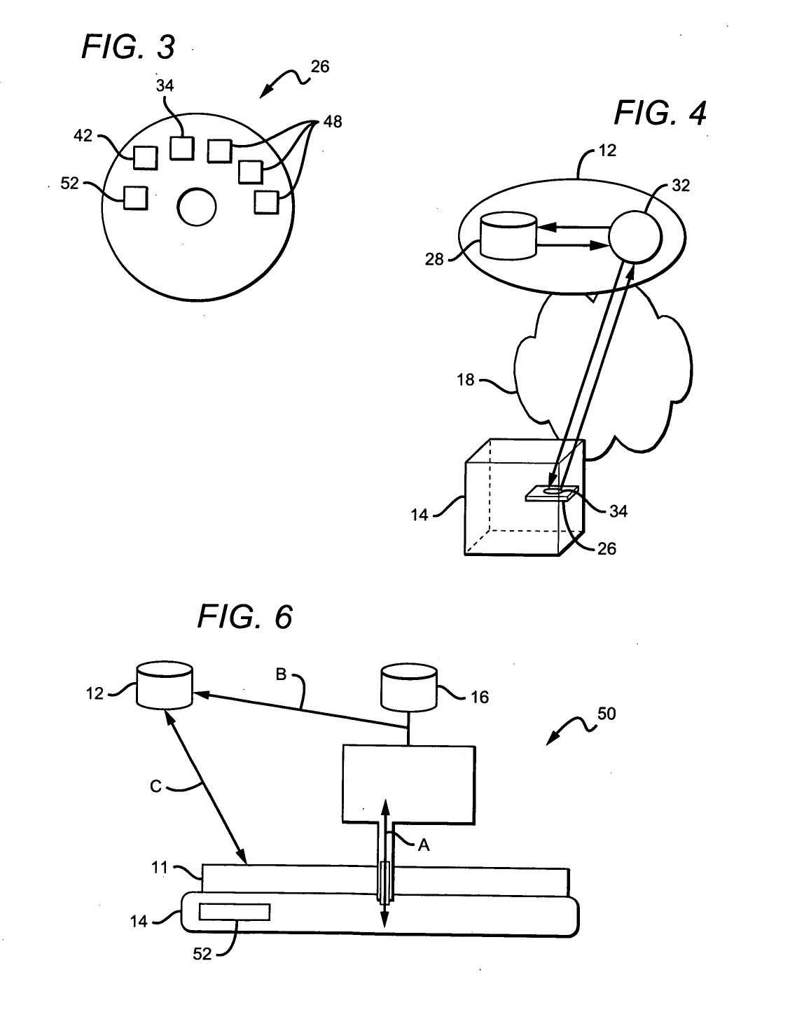

With reference to FIG. 3, in preferred embodiments, data files or data 48 are stored on the readable medium 26, wherein the stored data correspond to at least a portion of the data contained in the distributed data repository. The data stored on the readable medium 26 can be immediately displayed on the host device 14 upon initialization. The readable medium is configured to operate in conjunction with the digital publication system 11 so that a user can interact with the online portion of the digital publication system.

With reference again to FIGS. 1 and 2, the membership database 28 resides on, or is coupled to, the content provider system 12. The membership database 28 contains membership information, including but not limited to, user name, password, electronic mail address, postal mailing address, membership profile information, and status of membership.

The authentication system 30 is a software program that identifies and confirms that the user attempting to access the readable medium 26 is an authorized user. The authentication system 30 comprises a server authenticator 32 and a local authenticator 34. In preferred embodiments, the server and local authenticators are software applications and operate in conjunction with each other to provide user access to the readable medium 26 for the purpose of allowing the transmission and receipt of content by the user, wherein the content can be resident on any source, including, but not limited to, the content provider system and third party participants of the distributed data repository (discussed below). In preferred embodiments, the server authenticator 32 is resident on the content provider system 12 and the local authenticator 34 is resident on the readable medium 26 (see FIGS. 1 and 3).

With reference to FIG. 4, upon initialization of the readable medium 26 by the host device 14, the local authenticator 34 transmits a request to the server authenticator 32 to verify whether the user is allowed to access the readable medium 26. The server authenticator 32 accesses the membership database 28, retrieves the membership profile, verifies the membership status of the user, and transmits profile and status information to the local authenticator 34. Based upon the profile and status information, predefined portions of the readable medium 26 are initialized and personalized for the user. In some preferred embodiments, the authentication process is performed in each instance that a user requests a unique content item. In this regard, the authentication system 30 is configured to reaffirm that the user is authorized to access and receive each requested content item. In other preferred embodiments, a single authentication can be performed upon initialization, or authorization can be provided for sets or groups of content.

The data distribution system 40 is configured to request data for distribution to the host device 14 and to determine the hardware capabilities of the host device 14 for the purpose of determining the type and amount of content to transmit. In preferred embodiments, some of the data stored in the distributed data repository (discussed below) may be stored in multiple configurations, wherein the multiple configurations reflect varying system capabilities. Upon request for a particular data file from the host device 14, the data distribution system 40 can select the appropriate configuration of the data for transmission to the host device 14, as determined by the system capabilities of the host device 14.

With reference again to FIG. 2, the data distribution system 40 comprises a data request manager 42, a data locator 44, and a distributed data repository 46. The data request manager 42 is a software program that is configured to identify its host device 14 (for example, a personal computer or iPod), the system properties of the host device 14 (for example, RAM capabilities and processing power), and the environment of the host device (for example, network connection speed and type) automatically upon initialization. The data request manager 42 resides on the readable medium 26 and communicates with the data locator 44 in a client-server relationship, wherein the data request manager 42 executes client-type functions and the data locator 44 executes server-type functions. Once identified, the data request manager 42 transmits the bandwidth potential and system capability data to the data locator 44.

The data locator 44 is a software program configured to receive the system capability data from the data request manager 42. The data locator 44 resides on the content provider system 12 (see FIG. 1) and communicates with the data request manager 42. Upon receipt of the system capability data, the data locator 44 transmits the location of the content that the host device 14 is capable of displaying to the data request manager 42.

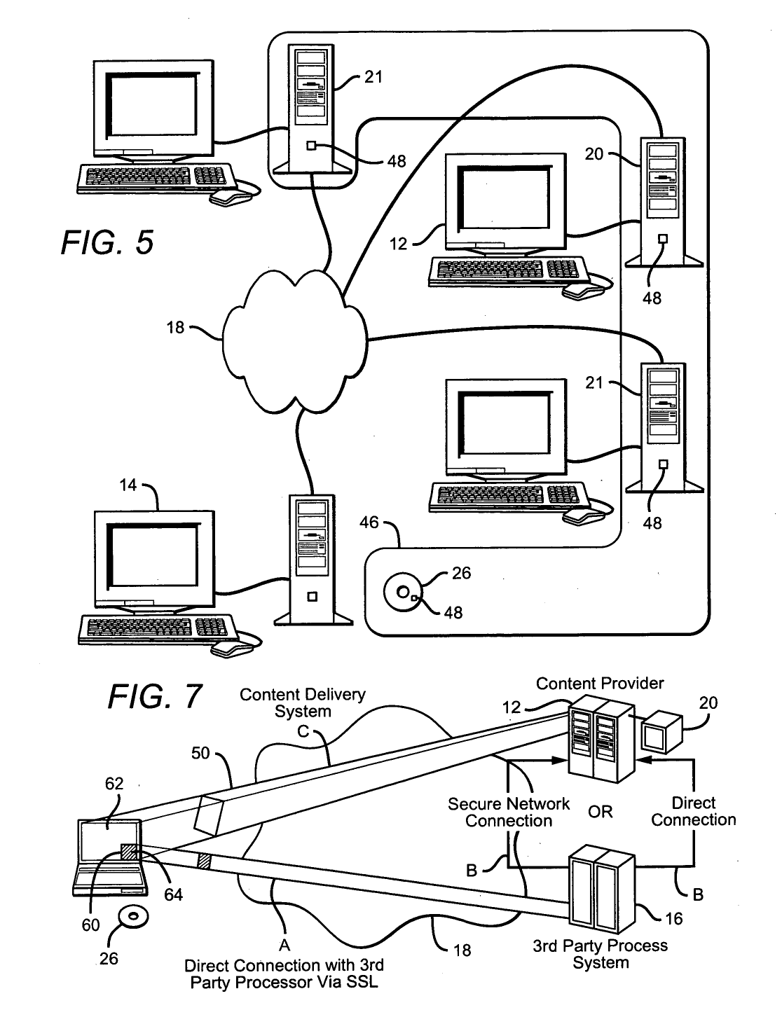

With reference to FIG. 5, the distributed data repository 46 contains data 48 which may be stored directly or indirectly on the content provider system 12, on at least one storage device 20 coupled to the content provider system 12, or a third-party storage device(s) 21, or any combination thereof, coupled to the content provider system 12. In some preferred embodiments, the distributed data repository 46 comprises a plurality of storage devices. In some preferred embodiments the storage devices reside in various physical locations, including but not limited to, the content provider system 12, storage device 20, the readable medium 26, and third-party storage devices 21. The data 48 includes, but is not limited to, text, graphics, multimedia presentations, movies, movie clips, audio files, pictures, photographs, and banner advertisements.

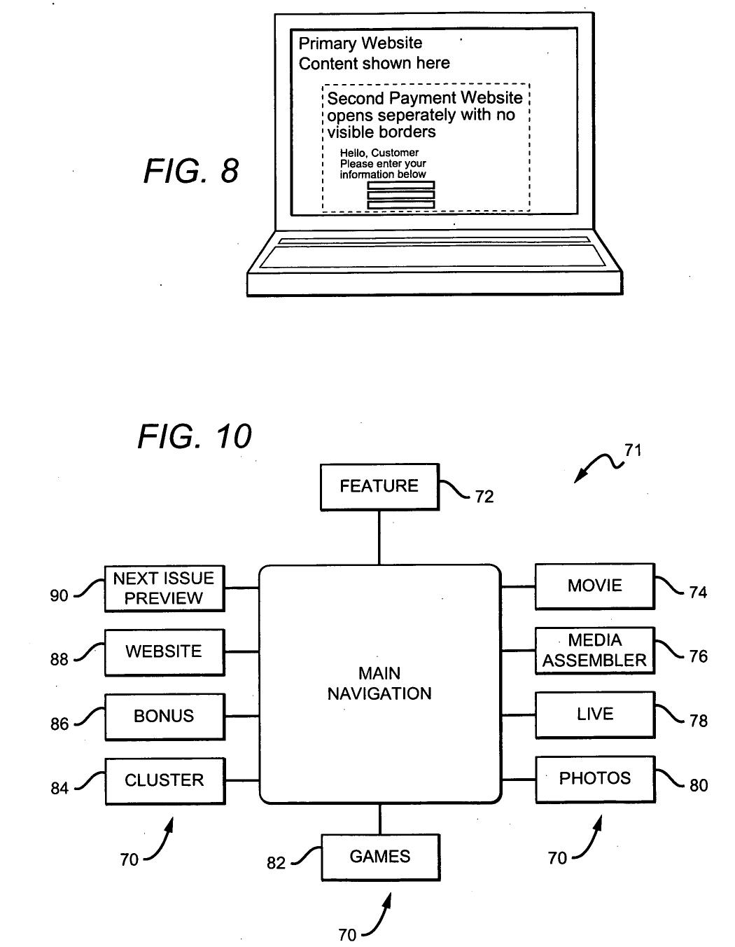

With reference to FIGS. 6 and 7, the secure processing system 50 secures the transmission of information from the host device 14 to the payment processor system 16, and further allows secure transmission of data between the host device 14 and the content provider system 12. The secure processing system 50 comprises a secure protocol application 52 designed to operate on the host device 14, and a plurality of communication paths A, B, C. Embodiments of the secure protocol application 52 are configured to prohibit visibility of client input (such as keyboard strokes, mouse or other input device data) to the content provider system 12 and to third parties unrelated to the transaction. The secure protocol application 52 resides on the host device 14 (see FIG. 3) and further prohibits the visibility of information transmitted between the host device 14 and the payment processor system 16. In one preferred embodiment, the secure protocol application 52 is a provider-designed web browser, although other software applications, or hardware solutions can also be suitable. In preferred embodiments wherein the secure protocol application 52 is a provider-designed web browser, the web browser is presented to the user without visible borders (see FIG. 8). In this embodiment, it appears to the user as though the user is still on the web page selected by the user; however, the user's network connection has been switched to access the independent third-party payment processor system 16. The effect is best compared to a picture-in-picture 60 broadcast on a television.

In preferred embodiments wherein the secure protocol application 52 is a provider designed web browser, the secure protocol application 52 is configured to allow basic web operations, including, but not limited to, opening a uniform resource locator (“URL”), transmitting the user to a prior URL stored in a history listing (as is commonly understood), transmitting the user forward to the next URL stored in the history listing, and displaying a print dialog box. Further, the secure protocol application is configured to provide dimension data of the web browser for display on the host device 14.

To secure the viewing or recording of the user information from the content provider system 12, the secure protocol application does not include any callback or ‘retrieve’ software application or script that would allow for the recall of the content of the web browser. Further still, the secure protocol application does not save the web browser page, or its contents, in the local cache of the content provider system 12 and is configured to prevent the ‘save’ event from occurring.

The communication paths A, B, C are communication links between the host device 14, payment processor system 16, and the content provider system 12. With reference to FIG. 6, communication path A exists between the host device 14 and the payment processor system 16. This communication path is a secure link from which the content provider system 12 is prohibited from viewing or recording any user input, including but not limited to, keystrokes and other data from input devices. With reference to FIG. 7, although the user is able to view the data presented via transmissions 62, 64, respectively, from the content provider system and the third party processor simultaneously in a picture-in-picture 60 type representation, the content provider system is unable to view or record any data or transmissions between the host device 14 and the payment processor system 16. In this regard, the content provider system 12 does not have access to, or the ability, to record user payment information or other private information, including but not limited to, credit card data and specified personal user information. In one preferred embodiment, the communication path A is a secure sockets layer (“SSL”), although any protocol allowing for the secure transmission of data is suitable.

Once the payment processor system 16 successfully processes the user payment, notification of successful payment is transmitted to the content provider system 12 via communication path B. (See FIGS. 6 and 7.) The content provider system 12 records the notification and notifies the content provider system 12 that the process is complete. In one preferred embodiment, communication path B is secure; however, as it is not transmitting private or critical information, communication path B is not required to be secure. In one preferred embodiment, the communication path B is created by SSL protocol, although any protocol allowing for the secure transmission of data is suitable.

In one preferred embodiment, upon receipt of notification of payment by the content provider system 12 communication path C is made available to the host device 14. Communication path C allows the host device 14 access to the content provider system 12 such that the digital publication system 11 (see FIG. 2) operating on the host device 14 can authenticate the user for access to content. In one preferred embodiment, the communication path C is created by SSL protocol, although any protocol allowing for the secure transmission of data is suitable.

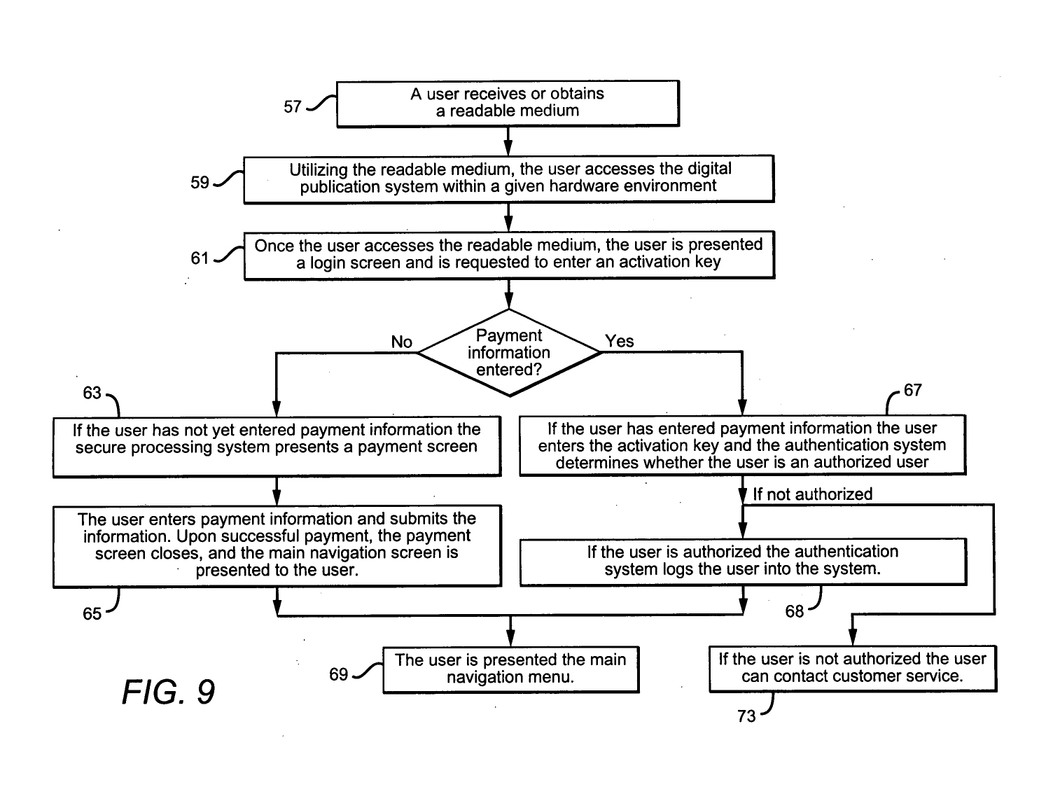

With reference to FIG. 9, in operation, in preferred embodiments, the user receives or obtains a readable medium 57. Utilizing the readable medium, the user accesses the digital publication system within a given hardware environment 59, for example, a personal computer or a handheld device. (See FIG. 1.) Upon accessing the readable medium the user is presented a login screen. The login screen requests the user to enter an activation key, such as a password, that was provided to the user in conjunction with the readable medium 61.

If the user has never entered payment information, for example, credit card information, the secure processing system presents a payment screen (for example, transmission 64, FIG. 7) to the user 63. The user enters payment information and submits the information to the payment processor system. Upon successful payment, the payment screen closes, and the main navigation screen is presented to the user 65.

If the user has previously entered payment information, the user enters the activation key and the authentication system determines whether the user is an authorized user 67. If the user is authorized, the authentication system logs the user into the system 68 and the user is presented the main navigation menu 69. If the user is not authorized the user can contact customer service. 73. In one preferred embodiment, a user can sign up for a month-to-month subscription, or for a predefined period of time. If the user signs up for a month-to-month subscription, if the user allows the subscription to lapse at the end of the month, any readable mediums 26 in the user's possession will expire and the user will no longer have access to any dynamic data accessible from the readable medium. In some preferred embodiments, the entire readable medium will be inaccessible upon expiration.

If the user elects to sign up for a subscription for a predefined time frame, for example, six (6) months, in some embodiments, the user may receive a reduced per-month price for the subscription. In these embodiments, if the user cancels the subscription prior to the end of the predefined time period, the user's price per month will be increased for the number of months the user maintained the subscription. For example, if a user subscribes for a six (6) month period for $19.95 per month, but cancels at the third month, the user may be billed $49.95 for each of the three months in which the subscription was active. In these embodiments, the additional billing information can be automatically transmitted to the payment processor system 16 from the content provider system 12 for automatic invoicing to the user. In some preferred embodiments, the entire subscription period is pre-charged to the user, and thus, if the user cancels earlier than the agreed upon period, a refund of any funds due the user can be offset with the higher per month charge. In this regard, there is no further billing to the user's credit card; rather, a refund is credited which accounts for the difference in monthly billing rates. In some embodiments, no cancellation is allowed after a certain period of time. Similar to the month-to-month subscription, upon expiration of the subscription, any readable medium 26 in the user's possession will expire such that the user no longer has access to any dynamic data accessible from the readable medium. In some preferred embodiments, the entire readable medium will be inaccessible upon expiration.

With reference to FIG. 10, as discussed above, the readable medium facilitates access to an online membership program. The online membership program is presented to the user via a series of web pages. In preferred embodiments, when the user enters the digital publication, a main navigation menu is presented to the user. The main navigation menu 71 includes a plurality of buttons 70 reflecting various subject topics or themes. The structure of the main navigation screen can be compared to the section headings of a table of contents in a printed publication. However, in contrast to a traditional print publication, the buttons 70 (section headings) provide access to a wide variety of dynamic and static content accessible via clicking on the buttons.

Upon selection of a particular button 70, a portion of the digital publication related to the selected button is opened and presents the user with options to review content related to that portion or to interact with that portion. For some buttons, a menu of categories of the subject matter relating to the selected button is displayed to the user. For example, if a user selects the movie section the display can present a variety of information relating to movies, including, but not limited to, various video clips available to be played, titles of available video clips, a search box in which to enter key words for searching movie titles, navigation by pagination tool (for example, listings by alphabet, category or page number), categories of video clips, and the like. In one embodiment, the main menu includes, but is not limited to, at least one feature link 72, a movie link 74, a media assembler link 76, a live video link 78, a photographs link 80, a game link 82, a cluster link 84, a bonus link 86, a website link(s) 88, and a next issue preview link 90. As publications can change format, these links could change.

The feature link 72 directs the user to the feature section of the publication. The feature section can include a featured personality, such as a celebrity or person of interest. In some embodiments, the feature section includes, but is not limited to, interviews, behind the scene footage, interactive features and photographs.

The movie link 74 directs the user to a movie section of the publication. The movie section can include movie clips and full-length movies. The movie section will include a list of popular movie clips, and in some embodiments, will highlight at least one new movie. To accommodate user connection abilities, each movie clip will include a low and high-speed stream. The movie section allows full movie download to the user and further allows the user to add movie clips to a favorite folder.

If a user decides to watch a movie, the movie can be viewed via real-time download, or can be stored on the user's local storage device. If the user decides to store the movie for later viewing, the user may be required to enter his password to access the movie. In preferred embodiments, the movie is time restricted, and thus, can be protected from excessive copying and transfer to users not authorized to view the movie.

To view a movie, the user selects the movie link from the main navigation menu 71. In some preferred embodiments the user can utilize a search box in which to enter key words for searching movie titles or a navigation-by-pagination tool (for example, listings by alphabet, category or page number). Once the user has accessed the movie section, the user selects the movie to watch. Each movie or video clip can be streamed using streaming methods well known in the industry, including currently accepted file dependent industry-standard concepts, such as those commonly known as progressive, real-time and buffered real-time.

In addition to streaming movies, the user can download the entirety of the movie file for later viewing and store the movie file in the local storage device coupled to, or resident on, the host device 14. When the user desires to view the movie, the user accesses the movie from the local storage device. The movie will remain accessible for a predefined period of time.

In some preferred embodiments, the digital publication further includes a download manager. The download manager is a software tool that allows a user to download user selected content to the host device 14. By allowing user selected content to be downloaded to the host device 14, repetitive downloading of the same content, for example, a popular movie, is avoided, thereby reducing the cost of monthly expenses for the content provider system 12.

During operation of the download manager, a user clicks on a download link which operates to transmit the user selected data to a predefined folder on the host device 14. In preferred embodiments, the selected data is injected or integrated with an executable file that verifies the user's status, that is, verifies whether the user's subscription to the digital publication is current, before displaying the data to the user. In this regard, the data, such as a movie, is not downloaded or distributed as independent data, for example, a stand-alone movie which can be opened with standard players such as Windows Media Player or Real Networks Real Player. Indeed, due to the requirement to verify the user's subscription status, that is, whether the user is a current subscriber to the digital publication system, the authentication process, which is performed each time before the downloaded data can be viewed on the host device 14, protects the content provider system 12 from redistribution of licensed content, and further ensures that upon expiration of the user's subscription, the user no longer has access to view or display the data. Indeed, in one preferred embodiment, the time period automatically expires if the user's membership expires.

In some preferred embodiments, if the content provider system 12 determines that the movie should be disabled or recalled for any reason, the content provider system 12 can revoke viewing access or completely remove the content. In one preferred embodiment, to change the authorized period of time, the content provider system 12 issues a notice that is retrieved by the host device 14 the next time the host device 14 accesses an on-line connection, for any reason, and does not require the host device 14 to specifically access the provider system 12.

If the user maintains an ongoing subscription to the digital publication, the predefined time period for the downloaded movie can be reset from the content provider system as new issues of the publication are sent to the user.

Once the predefined period of time expires, when the user attempts to initiate the playing of the movie, a user interface is launched and displays a request to the user to enter a valid user name and password. The user interface includes software instructions that are configured to receive the user name and password and verify the current validity of the password by accessing the membership database 28. If the user is currently on-line, the interface can verify the password. If the password is valid, the movie will commence play. If the user is off-line, the user is prompted to access the network so the password can be verified. If the password is invalid or has expired, the user is transmitted to the content provider system 12 to renew the membership. Once the user renews membership the user can commence the play of the movie. In preferred embodiments, the movie or video can play from the interface of the digital publication system, such as a flash projector. In preferred embodiments, the player allows for the control of the content, including, fast-forward, rewind, pause, stop, and start. However, it is to be understood that any software program configured to allow the display of the content, including, but not limited to, any commercially available player, such as, Windows Media Player by Microsoft®, RealPlayer by RealNetworks, QuickTime Player by Apple®, or any other default software program resident on the host device 14, is suitable.

To allow for more efficient downloading of data, in preferred embodiments, the digital publication system automatically detects the speed of the network connection between the host device 14 and the content provider system 12 and dynamically adjusts the downloadable bit rate to the host device 14. In this regard, the user's experience is enhanced as the downloading of data to the host device 14 is optimized and thus, more compatible with the user's equipment.

The media assembler link 76 allows the user to create a user-defined movie, wherein a user can arrange various video clips, storyboard fashion, and compile those clips into a playable or downloadable movie. In preferred embodiments, the user is not required to provide source material for the user-defined movie, but rather, can utilize pre-identified content from the content provider system 12. In this regard, a user is allowed to create his own story line and outcome, and can alter the story line and outcome in any manner.

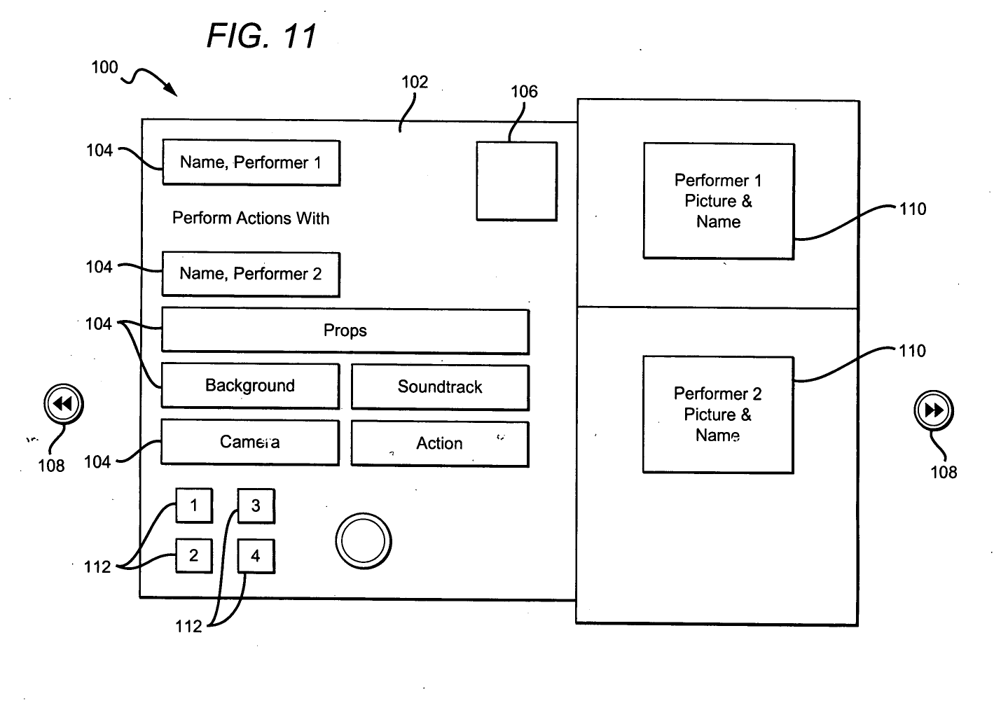

In preferred embodiments, and with reference to FIG. 11, the media assembler 100 comprises a storyboard 102, a plurality of selection buttons 104, a preview window 106 and player control buttons 108. In one preferred embodiment, the media assembler further comprises a performer display window 110.

The storyboard 102 comprises a plurality of segments 112, wherein the combination of segments creates the user-defined movie. In preferred embodiments, the average segment length is three minutes, and an entire user defined movie can average twenty-one (21) minutes.

Each selection button 104 allows the user to choose parameters for a specific aspect or feature of the selected segment 112. In a preferred embodiment, the selection buttons 104 include a performer list, an action list, a prop list, assorted backgrounds, camera angle variations, assorted soundtracks, and the like.

Upon choosing a selection button 104, a menu is presented, wherein the content of the menu is associated with the particular selection button 104. For example, if the selection button is related to the background of the scene, the menu may include background options, such as, beach, mountains, office and the like. In preferred embodiments, the menus can be of various styles including, but not limited to, pop-up, pull-down, input text based, and slide-out. The source material for each menu selection can be a static image, an audio file, a video clip, or a video producing application (such a vector based flash movie or application). For example, if the user selects a beach background, the background can be a static image of a beach, or a video clip depicting rolling ocean waves.

Once a choice is made from the menu options of the particular selection button 104, the choice is displayed while other options are being selected. If a user desires to change a selected option, the user simply revisits the menu for the particular selection and reselects a new option, which replaces the original selection.

In use, a user selects the background, music and actors, and further, selects the camera angle. Once the features of the first segment are selected, a user selects the aspects of the second segment. A user can play the first two segments in seriatim to determine whether the user desires to make any changes. This process continues until the user is satisfied with the individual segments and combinations thereof. In preferred embodiments, a user is not required to utilize all of the available segments, but rather, can create any custom length movie up to the limitation of the number of segments, and further can arrange the playing of the segments in any desired sequence.

To create the content for the menu selections, variations on activities, backgrounds and camera angles are filmed. In preferred embodiments, activities, such as tossing a ball, are filmed in front of a blue or green screen such that any background can be inserted. Further, the activities can be filmed from various camera angles, with for example, different lenses, different lighting, and other variations on the manner of filming.

In light of the vast amount of choices, and permutations in creating the underlying content, vastly different user defined movies can be created. Indeed, two users selecting identical activities could create vastly different movies depending upon the individual selections from each menu, for example, the choice of performers, props and scenes.

As the user's selections are made, the selections are stored in a volatile memory in the host device 14 in association with the particular segment in question (as discussed above). If the user desires to view the movie prior to completing the input selections, the user can play the combined selections in the preview window 106. In preferred embodiments, the preview window 106 is a display window that is smaller in size than the display area of the host device 14.

The player control buttons 108 are buttons that allow the control of the segment, and can include, a forward, reverse and play button. During compilation of the user-defined movie, the forward button advances the individual segments and advances between segments. Once the user has advanced to the end of the last assembled segment, depression of the forward button will convert the forward button to a play button. When the play button is depressed, depending upon the host device 14, the compiled segments can play in a full-screen presentation or can play in a display window larger than the preview window 106 allowing the user the option of playing the movie in full-screen mode.

In some embodiments, the media assembler 100 comprises the performer display window 110. In these embodiments, upon selection of the performer(s), the performer's name and, in some instances, a picture of the performer can be displayed in the performer display window. The display allows the user to view the performer and decide if the performer is appropriate for the movie.

With reference again to FIG. 10, the live link 78 directs the user to a live streaming video section of the publication. The live link allows for the transmission of live video content to the host device 14, such as interviews, performances and other live entertainment. As the video is live, the source for the live video link can be resident from the content provider system 12. To accommodate user connection abilities, each live transmission will include a low and high-speed strean.

The photograph link 80 directs the user to a collection of photographs. In some embodiments, this section allows the user to view hundreds of thousands of photographs. The content may be stored on the content provider system 12 or on any of the hosts storing content in the distributed data repository.

The game link 82 directs the user to a game listings section of the publication, including links to games resident on third-party websites or other online businesses. The game section can include any type of games, including, but not limited to, games which allow interactivity with other online users, solitary games, puzzles and the like. In one embodiment, a user directed game can be played wherein the user instructs a subject to perform different activities. For example, a clown (the subject) can be instructed to stick out his tongue, stand on one foot, pat his stomach and the like.

The cluster link 84 initiates a program that is configured to randomly select a plurality of data from anywhere in the database, including, for example, movies, video clips, photographs, and thumbnails, and simultaneously displaying the plurality of data to the user in a random manner. The data is rapidly displayed such that it can be moving towards the user, away from the user, or remain static. Individual sections of the magazine can include a cluster button, which creates a display more specific to the section of the magazine.

The bonus link 86 directs the user to a variety of extra features. For example, the bonus link can include wallpaper, funny out takes of movies, tutorials on various topics, screen savers, other types of downloadable content such as that for other mobile devices, and any other information the provider includes.

The website link 88 directs the user to other listings of websites that are associated with, sponsored by, or related to the digital publication. Upon access of the website link 88, a listing of websites is presented to the user. The user can click on any one of the listed website addresses and be transmitted to the website. In some preferred embodiments, the authorization system will be implemented for any content requested by the user from the linked website.

The next issue preview link 90 presents a preview of the next issue to the user. In this section, the user can view sample excerpts from random sections of the publication. In some embodiments, the preview allows the user to purchase the next issue in advance, if the user does not have a periodic subscription to the publication.

Although the preferred embodiments have been described with particular embodiments, the disclosure is not intended to be limiting, and can include other features or variations. For example, in some preferred embodiments, the publication includes a geographical tracking feature that filters locations that do not allow the distribution of the publication, such as, for example, adult content publications. In these instances, an alternative offer could be presented to the user. Additionally, in some embodiments, if a user purchases the publication by becoming a member of the associated website, the user name and password is transmitted to a fulfillment house, wherein the fulfillment house forwards the first and second readable media to the user. The fulfillment house prints the user name and activation key on the user's receipt that is sent by mail to the user. This allows the content provider system to identify uses of the digital publication to the specific user.

In still another preferred embodiment, a virtual “favorites folder” can be created for each user. The virtual folder represents a listing of content; however, the content list is not saved on the user device. In preferred embodiments, when a user selects particular content (for example, a specific photo) and then clicks “save to favorites” a record is made in the content provider system associating the user to the selected content. When the digital publication system is active on the host device 14, the record resembles a favorite's folder to the user and can contain multiple favorites.

In other preferred embodiments, the digital publication system further comprises an advertising system. The advertising system is a software application that is configured to transmit custom web based advertising banners to the host device 14. In preferred embodiments, the selection of the advertising banner will be based on the specific credit card processor the user used to purchase the subscription. For example, if the content provider system 12 utilizes multiple credit card processors processing subscriptions, and a particular subscription is processed through processor A, processor A will have record of the credit card transaction and the ability to process another transaction without requiring the user to enter the credit card information. In preferred embodiments, different products can be sold through processor A than through other processors. Removing the requirement to reenter payment information is beneficial in that it expedites the payment process and further, can increase sales. Although all variations of features have not been set forth, the foregoing is intended to cover all modifications and alternative constructions falling within the spirit and scope of the invention.

What is claimed:

1. A digital publication system configured to operate in conjunction with a communication network, the communication network having a content provider system, and a host device operated by a user, the host device having a set of system properties, and a set of operating properties comprising an operating environment, the content provider system and host device being coupled for communication therebetween, comprising:
an authentication system, wherein the authentication system is configured to provide authorization for the user to access the digital publication system;
a data distribution system comprising a distributed data repository, the data distribution system being configured to transmit at least a portion of the distributed data repository to the host device; and
a secure processing system, the secure processing system comprising a protocol application for securing the transmission of information to and from the host device, wherein securing the transmission prohibits the content provider system from accessing and viewing the information.

2. A digital publication system as claimed in claim 1, further comprising a readable medium, the readable medium being portable and storing at least a portion of the distributed data repository.

3. A digital publication system as claimed in claim 1, wherein the host device is a wireless device and is capable of receiving at least a portion of the distributed data repository via wireless transmission.

4. A digital publication system as claimed in claim 1, wherein the authentication system further comprises a server authenticator and a local authenticator, wherein the server authenticator and local authenticator operate in conjunction with each other to provide authorization to allow the transmission and receipt of content by the host device.

5. A digital publication system as claimed in claim 2, wherein the authentication system further comprises a server authenticator and a local authenticator, wherein the server authenticator resides on the content provider system and the local authenticator is resident on the readable medium.

6. A digital publication system as claimed in claim 5, wherein the server authenticator and local authenticator operate in conjunction with each other to provide authorization to allow the transmission and receipt of content by the host device.

7. A digital publication system as claimed in claim 1, further comprising a membership database.

8. A digital publication system as claimed in claim 1, further comprising a third party processor, wherein the secure payment processor transmits information between the host device and the third party processor.

9. A digital publication system as claimed in claim 1, the secure processing system comprising:
a secure protocol application; and
at least one communication path, wherein the secure protocol application is configured to secure the transmission of the information from the host device to the third party computer, wherein the securing the transmission prohibits the provider computer from accessing and viewing the transmitted information.

10. A device as claimed in claim 9, wherein the communication path of the secure processing system is a secure socket layer.

11. A device as claimed in claim 9, wherein the secure protocol application is a web browser.

12. A digital publication system, as claimed in claim 1, wherein the digital publication further comprises a series of web pages, the web pages containing static and dynamic data.

13. A digital publication system as claimed in claim 1, the data distribution system further comprising:
a data request manager, wherein the data request manager resides on the readable medium, the data request manager being a software program that is configured to identify the host device, identify system properties of the host device, and identify the operating environment of the host device; and
a data locator 44, wherein the data locator resides on the content provider system; and wherein the data locator and data request manager communicate with each other in a client-server relationship.

14. A digital publication system as claimed in claim 1, further comprising a media assembler, the media assembler being an interactive software program for the creation of a user-defined movie.

15. A digital publication system as claimed in claim 1, further comprising:
a download manager, wherein the download manager is a software program that allows the downloading of data from the digital publication system for storage on the host device, and is configured to verify whether the user is authorized to view the downloaded data each time the user attempts to view the downloaded data stored on the host device.

16. A method for distributing a digital publication, the digital publication being configured to operate in conjunction with a communication network, the communication network having a content provider system, and a host device operated by a user, the host device having a set of system properties, and a set of operating properties comprising an operating environment, the content provider system and host device being coupled for communication therebetween, comprising:
providing a portable readable medium to the user, the portable readable medium identifying at least a portion of data available from the digital publication;
determining, upon access of the readable medium by the host device, whether the user is authorized to access the digital publication system;
if the user is authorized to access the digital publication system, initializing at least a portion of the readable medium for access by the user;
identifying the system properties and operating environment of the host device; and
transmitting the selected data to the host device in accordance with the system properties and operating environment of the host device.

17. A digital publication distribution method as claimed in claim 16, further comprising:
receiving, by the content provider system, a request from the host device to display data selected from the initialized portion of the readable medium by the user;
determining whether the user is authorized to access and receive the requested data; and
transmitting from the content provider system to the host device, authorization for the host device to receive and display the requested data.

18. A digital publication distribution method as claimed in claim 16, further comprising:
presenting a provider-defined web browser to the host device, the web browser being configured to accept user information;
reassigning the host device's network connection to a connection allowing access to a third-party processor computer; and
transmitting to the third party processor, via the connection to the third party-processor, the user information, wherein the connection to the third-party processor restricts the content provider system from viewing or recording the transmitted user information.
